(19) United States
(12) Patent Application Publication
(10) Pub. No.: US 2025/0319835 A1
(43) Pub. Date: Oct. 16, 2025

(54) CRASH MANAGEMENT SYSTEM FOR A VEHICLE AND A METHOD FOR PRODUCING THE SAME

(71) Applicant: BENTELER AUTOMOBILTECHNIK GMBH, Paderborn (DE)

(72) Inventors: Joern TOELLE, Paderborn (DE); Alex MIRAU, Bad Lippspringe (DE); Friedrich BOHNER, Oerlinghausen (DE); Tobias Svantesson KAVIK, Oslo (NO); Odd Harry MANNSVERK, Oslo (NO)

(21) Appl. No.: 19/176,156

(22) Filed: Apr. 11, 2025

(30) Foreign Application Priority Data
Apr. 12, 2024 (EP) 24169970.1

(51) Int. Cl. B60R 19/18

(52) U.S. Cl. CPC B60R 19/18; B60R 2019/182

(57) ABSTRACT

A crash management system for a vehicle includes a cross member and two crash absorbing components, wherein the cross member and the two crash absorbing components are made from a single extruded profile which includes at least two profile chambers which extend in longitudinal direction (R) of the single extruded profile. A method for producing such a crash management system is also described.

### RELATED APPLICATIONS

The present application claims priority of European Application Number 24169970.1 filed Apr. 12, 2024, the disclosure of which is hereby incorporated by reference herein in its entirety.

### FIELD

The present disclosure relates to a crash management system for a vehicle. The present disclosure further relates to a method for producing a crash management system for a vehicle.

### BACKGROUND

Crash management systems are installed at the front and at the rear of motor vehicles in order to absorb the impact energy of minor impacts, so that the damage inflicted on the actual base frame of the vehicle is reduced.

A crash management system includes a cross member and two crash absorbing components, wherein the cross member is able to be transversely fixed to longitudinal members of the vehicle frame via the two crash absorbing components. The cross member transfers the energy resorting from an impact into the two crash absorbing components, where the impact energy is predominately converted into deformation work.

The two crash absorbing components, which are designed as crash boxes, are welded to the cross member of the crash management system. However, this leads to a high local heat input, which is able to have a negative effect on the rigidity of the material of the crash management system. Additionally, the welding seams pose a weakness in case of an impact with subsequent deformation of the crash management system, which is able to result in the crash absorbing components tearing away from the cross member. This risk exists in the event of a head on collision with a pole (pole test), which results in a strong deformation of the cross member and therefore places at lot of stress on the areas connecting to the crash absorbing components. This is of growing importance for vehicles with high mass, e.g., battery electric vehicles (BEV).

In order to avoid these disadvantages, crash management systems where the cross member and the two crash absorbing components are made and formed from a single extruded profile in one piece and of the same material. A welding operation to connect the cross member with the crash absorbing components is therefore not necessary. Additionally, the production process of the crash management systems is simplified, as no separate manufacturing of the crash absorbing components and the cross member is necessary. This reduces production costs. A respective crash management system is described in EP 2 322 387 B1.

### SUMMARY

The objective of the present disclosure is to provide an improved crash management system for a vehicle, which is able to be produced cost efficiently and provides a stable connection between crash absorbing components and a cross member and which is able to absorb a high amount of impact energy. A further objective of the present disclosure is to provide a method for producing such a crash management system.

The first task is solved by a crash management system for a vehicle. The second task is solved by a method for producing a crash management system for a vehicle.

According to the present disclosure, the crash management system for a vehicle includes a cross member and two crash absorbing components. The cross member is able to be referred to as a beam and the two crash absorbing components are designed as crash boxes.

At least one of the two crash absorbing components as well as the cross member are made from a single extruded profile which includes at least two profile chambers which extend in a longitudinal direction of the single extruded profile. This has the advantage that the at least one crash absorbing component does not have to be welded to the cross member which simplifies the production process and ensures that the crash management system does not have weaknesses in the form of welding seams.

The cross member includes at least one profile chamber of the at least two profile chambers of the single extruded profile. The free end sections of the cross member are able to be bent, so that the cross member includes a straight middle section and curved free end sections.

In at least one embodiment of the present disclosure, at least one of the two crash absorbing components is formed from the single extruded profile in one piece and of the same material by bending two profile segments of the at least one remaining profile chamber of the at least two profile chambers backwards. The term “backwards” refers to the position of the components in a vehicle. The two profile segments are initially positioned on opposite sides of a base area of the single extruded profile. In order to perform the bending operation, both of the segments should be partly separated from the at least one profile chamber of the cross member. This separation is carried out in a precutting stage. The base area is a section of the at least one of the at least two profile chambers that forms a part of the at least one of two crash absorbing components that remains connected to the at least one profile chamber of the cross member.

The at least one of the two crash absorbing components includes at least two neighboring profile segments in a longitudinal direction of the cross member. If the crash management system is mounted in its designated position in the vehicle, the two neighboring profile segments of the at least one of the two crash absorbing components are positioned horizontally next two each other. The at least two neighboring profile segments extend transverse to the longitudinal direction of the cross member.

A crash management system with at least one crash absorbing component including two neighboring profile segments in a longitudinal direction of the cross member is beneficial for absorbing the impact energy in the event of an impact of the vehicle in which the crash management system is mounted.

The free end sections of the neighboring profile segments are able to be in contact with one another. However, a small gap between the neighboring profile segments in order to reduce the stress induced by the forming process is able to be beneficial.

In at least one embodiment of the present disclosure,, both of the two crash absorbing components are formed from the single extruded profile in one piece and of the same material. In this case, both crash absorbing components are formed by respectively bending two profile segments of the at least one remaining profile chamber of the at least two profile chambers backwards, so that both crash absorbing components include at least two neighboring profile segments in a longitudinal direction of the cross member which extend transverse to the longitudinal direction of the cross member. The crash management system is able to be formed mirror-symmetrically with regard to a mirror plane cutting through the middle of the crash management system, perpendicular to the longitudinal direction of the cross member. This ensures that the impact energy is distributed evenly between the cross member and the crash absorbing components.

In at least one embodiment of the present disclosure,, the cross member and at least one of the two crash absorbing components are made from a single extruded profile including three, or five profile chambers in longitudinal direction. The use of three or five profile chambers offers a greater freedom in the design of the crash management system. The profile chambers are able to be designed mirror-symmetrically with respect to a mirror plane which horizontally cuts the crash management system through the middle when the crash management system is mounted in its designated position at the front or rear of the vehicle. This ensures an even distribution of the impact energy.

In a further embodiment, at least one free end section of the cross member includes an end section of the at least one profile chamber from which the at least one crash absorbing component is formed. In order to achieve this, the pre-cut carried out to partly separate the outer profile segment from the at least one profile chamber of the cross member does not extend to the free end section of the cross member. The outer profile segment that is bent backwards is thus separated from the end section which remains attached to the free end section of the cross member. This has the advantage, that the length of the at least one crash absorbing component is able to be directly determined by the length of the pre-cut along the longitudinal direction of the single extruded profile. The end section of the at least one profile chamber from which the at least one crash absorbing component is formed that remains attached to the end section of the cross member has the additional advantage of stabilizing the cross member. This is true if the cross member includes at least two profile chambers, which enclose the at least one profile chamber of the at least one crash absorbing component. In this case, the end section is able to connect the at least two profile chambers of the cross member, which stabilizes the connected profile chambers and thus the cross member.

In at least one embodiment of the present disclosure, a middle section of the cross member includes a middle section of at least one of the profile chambers from which at least one of the crash absorbing components is formed. Here, the pre-cut carried out to partly separate the inner profile segment from the at least one profile chamber of the cross member does not extend to the pre-cut of the other middle segment or the other crash absorbing component. Thus, a middle section of at least one profile chamber from which the at least one crash absorbing component is formed remains attached to the middle section of the cross member. This has similar advantages to the previously described embodiment, namely that the length of the inner segment is able to be adjusted depending on the desired length of the crash absorbing component and increased stability of the cross member.

If the cross member and the at least one crash absorbing components are made from a single extruded profile including three or more profile chambers in a longitudinal direction, one of the profile chambers is able to be arranged between the profile chambers of the cross member and the at least one crash absorbing component. This has the advantage that the longitudinal cuts performed in the pre-cutting process, in which the at least one profile chamber from which the at least one crash absorbing component is formed is partly separated from the remaining at least one profile chamber of the cross member, is able to extend through the profile chamber arranged between the profile chambers of the cross member and the at least one crash absorbing component. Cutting through the wall to connect the at least one profile chamber is not necessary from which the at least one crash absorbing component is formed and the at least one remaining profile chamber of the cross member. This greatly simplifies the cutting process.

In at least one embodiment of the present disclosure, if the height of the connecting profile chambers arranged between the profile chambers of the cross member and the at least one of the two crash absorbing components is smaller compared to the height of the profile chambers of the cross member and the at least one crash absorbing component. The height of the profile chamber refers to the height of the chamber when the crash management system is mounted in the vehicle. This has the advantage, that the pre-cuts in a longitudinal direction of the single extruded profile are able to be carried out by cutting through the connecting profile chambers while ensuring that the connecting profile chambers themselves are as small as possible. The height of the connecting profile chambers is large enough to ensure an even cut is beneficial. The height of the connecting profile chambers ranges from 5 mm to 15 mm.

In at least one embodiment of the present disclosure, the height of the crash management system ranges from 100 mm to 250 mm, from 150 mm to 220 mm. The sum of the individual heights of the profile chambers, from which the crash absorbing components are formed, accounts for 40% to 60% of the overall height of crash management system. The height of the profile chambers is able to be adjusted to the individual needs and requirements of the designated vehicle.

In at least one embodiment of the present disclosure, the wall thickness of the at least one profile chamber of the cross member is higher compared to the wall thickness of the at least one profile chamber of the at least one crash absorbing component. The wall thickness of the at least one profile chamber of the cross member is higher, to ensure a higher stiffness in comparison to the at least one crash absorbing component.

The wall thickness of the profile chambers ranges from 1 to 15 millimeters, or from 3 mm to 8 mm.

In at least one embodiment of the present disclosure, the crash management system is made out of a 6000 or 7000 series aluminum alloy with a tensile strength ranging from 200 MPa to 400 MPa.

At least one of the two crash absorbing components is able to be formed from profile segments of an inner profile chamber of the single extruded profile, while the cross member is formed from outer profile chambers of the single extruded profile. In this embodiment, the cross member encloses the at least one crash absorbing component. This ensures an even distribution of the impact energy within the crash management system and leads to a beneficial forwarding of the impact energy from the cross member into the crash absorbing components.

In a further advantageous embodiment, at least one of the two crash absorbing components is able to be formed from profile segments of outer profile chambers of the single extruded profile, while the cross member is formed from an inner profile chamber of the single extruded profile. In this embodiment, the at least one crash absorbing component includes two sets of two neighboring profile segments on vertically opposite sides of the cross member.

In at least one embodiment of the present disclosure, a towing sleeve is integrated into the crash management system. In at least one embodiment of the present disclosure, the towing sleeve is positioned in the vicinity of the base area of at least one of the two crash absorbing components. In at least one embodiment of the present disclosure, the towing sleeve is not welded to the crash management system but rather screwed or clinkered to the crash management system.

In at least one embodiment of the present disclosure, reinforcing elements are able to be connected to the crash management system. This is able to be for example additional profiles placed between the two vertically neighboring sets of profile segments, in a central position of the beam in front or in between the chamber(s), or at the ends of the beam.

In order to connect the crash management system with the vehicle, the free ends of the crash absorbing components are able to include coupling elements, wherein the coupling elements are connected to the crash absorbing components by screwing, clinkering or clinching and only less by welding.

Also a backplate is able to be welded to the free ends of the crash absorbing components.

According to the present disclosure, the method for producing a crash management system for a vehicle which includes a cross member and two crash absorbing components includes the following steps:
Providing a single extruded profile, which includes at least two profile chambers in longitudinal direction of the single extruded profile.
Pre-cutting or slitting the single extruded profile to form at least two pre-cut profile segments and thereby partly separating at least one of the at least two profile chambers from the at least one remaining profile chamber of the at least two profile chambers. If both crash absorbing components are made by the method according to the present disclosure, four pre-cut segments are cut, two for each crash absorbing component. The at least two pre-cut profile segments include a section of at least one of the at least two profile chambers and remain attached to a portion of the single extruded profile. This portion forms a base area of the crash absorbing component to be formed that remains connected to the at least one remaining profile chamber of the cross member to be formed. The at least two pre-cut profile segments extend in longitudinal direction of the single extruded profile, starting from opposite sides of the base area.
Forming the at least one remaining profile chamber of the at least two profile chambers into the cross member shape, for example, by curving its end sections.
Forming at least one crash absorbing component by bending the at least two pre-cut profile segments away from the cross member in a backward direction. During the bending procedure, the pre-cut profile segments remain attached to the base area of the at least one crash absorbing component to be formed. The backward direction refers to the direction of the crash management system which faces the vehicle in the mounted state. Subsequently, the at least two pre-cut profile segments are pressed together in longitudinal direction of the cross member, so that the pre-cut profile segments are positioned next to each other in longitudinal direction of the cross member and extend transvers to the longitudinal direction of the cross member.

In at least one embodiment of the present disclosure, both crash absorbing components are formed by the above method.

In at least one embodiment of the present disclosure, one or more holes for mounting a towing sleeve is cut into the base area of the at least one crash absorbing component to be formed. This is done during the pre-cutting step. Afterwards a receiving block for connecting the towing sleeve with the crash absorbing system is able to be inserted into the profile chamber of the crash absorbing component to be formed and positioned under the hole cut into the base area.

In order to connect the crash management system with the vehicle, coupling elements as well as a backplate are able to be connected with the free ends of the crash absorbing components.

### BRIEF DESCRIPTION OF THE DRAWINGS

The present disclosure is further described by schematic drawings, which serve to facilitate the understanding of the various embodiments. The drawings show:

FIG. 1 a prospective view of a first embodiment of a crash management system according to the present disclosure,

FIG. 2 a front view of the first embodiment of the crash management system according to the present disclosure,

FIG. 3 a second prospective of the first embodiment of the crash management system according to the present disclosure,

FIG. 4 a detailed view of the first embodiment of the crash management system according to the present disclosure,

FIG. 5 the first embodiment of the crash management system according to the present disclosure with a top view on a horizontal cut at 50% height,

FIG. 6 a prospective view of the crash management system according to FIG. 5 according to the present disclosure,

FIG. 7 a detailed view of a second embodiment of the crash management system according to the present disclosure,

FIG. 8 a detailed view of a third embodiment of the crash management system according to the present disclosure,

FIG. 9 a detailed view of a fourth embodiment of the crash management system according to the present disclosure,

FIG. 10 a first step of a method for producing a crash management system according to the present disclosure; and

FIG. 11 a second step of the method for producing the crash management system according to the present disclosure.

### DETAILED DESCRIPTION

For identical components of the present disclosure the same reference signs are used, even though a repeated description is not carried out for reasons of simplification.

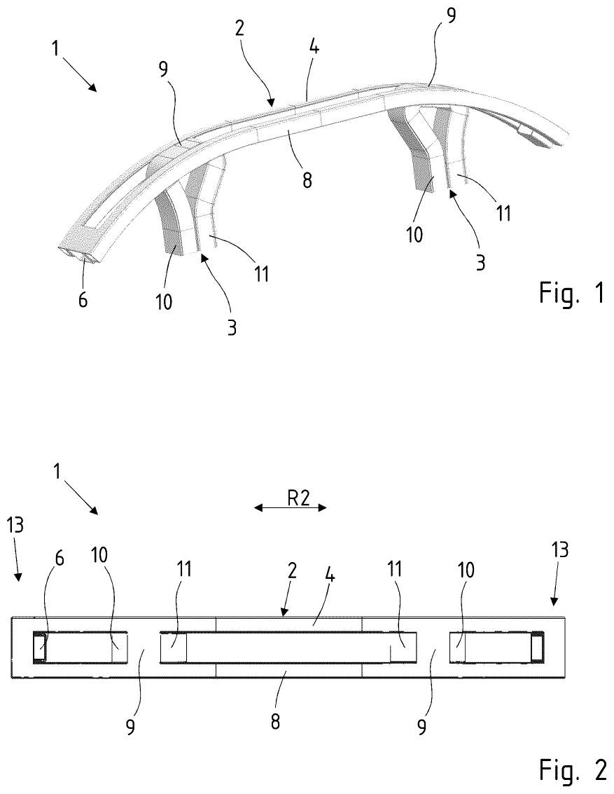

The FIG. 1-FIG. 4 show a first embodiment of a crash management system 1 for a vehicle according to the present disclosure. FIG. 1 shows a prospective view of the crash management system 1, which includes a cross member 2 and two crash absorbing components 3. The cross member 2 is able to be referred to as a beam, wherein the two crash absorbing components 3 are configured as crash boxes.

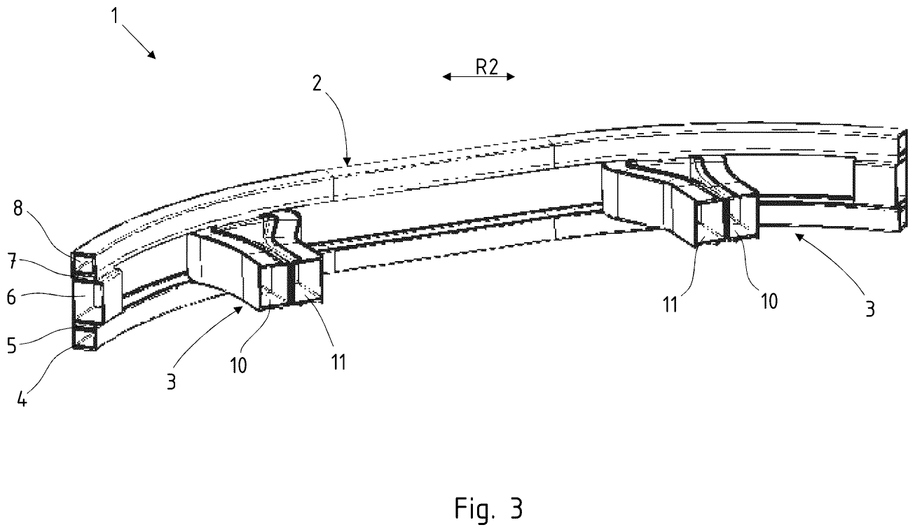

The cross member 2 and the two crash absorbing components 3 are made from a single extruded profile, which includes five profile chambers 4, 5, 6, 7, 8 which extend in longitudinal direction R1 of the single extruded profile 21 and the cross member 2. In FIG. 1-FIG. 4, the single extruded profile 21 is not shown in its original form, the five profile chambers 4, 5, 6, 7, 8 are able to be seen in the second prospective view of the crash management system 1 shown in FIG. 3. The profile chambers 4, 8 are referred to as outer profile chambers, the profile chamber 6 as inner profile chamber and the profile chambers 5, 7 as connecting profile chambers.

In accordance with the present disclosure, the two crash absorbing components 3 are formed from the single extruded profile 21 in one piece and of the same material by bending segments of the inner profile chamber 6 backwards on opposite sides of a base area 9, which is a section of the inner profile chamber 6 that forms a part of the crash absorbing components 3 and remains connected to the profile chambers 4, 8 of the cross member 2. Thus, the two crash absorbing components 3 include two neighboring profile segments 10, 11, which originate from the inner profile chamber 6. The two neighboring profile segments 10, 11 are positioned next to each other in longitudinal direction R2 of the cross member 2. The two neighboring profile segments 10, 11 extend transverse to the longitudinal direction R2 of the cross member 2.

In order to bend the two profile segments 10, 11 backwards, the profile segments 10, 11 are pre-cut or slit to partly separate them from the outer profile chambers 4, 8. The pre-cut is performed in longitudinal direction R1 of the single extruded profile 21, wherein the cut extends through the profile chambers 5 and 7, which are arranged between the profile chambers 4 and 8 of the cross member 2 and the inner profile chamber 6 from which the two crash absorbing components 3 are formed.

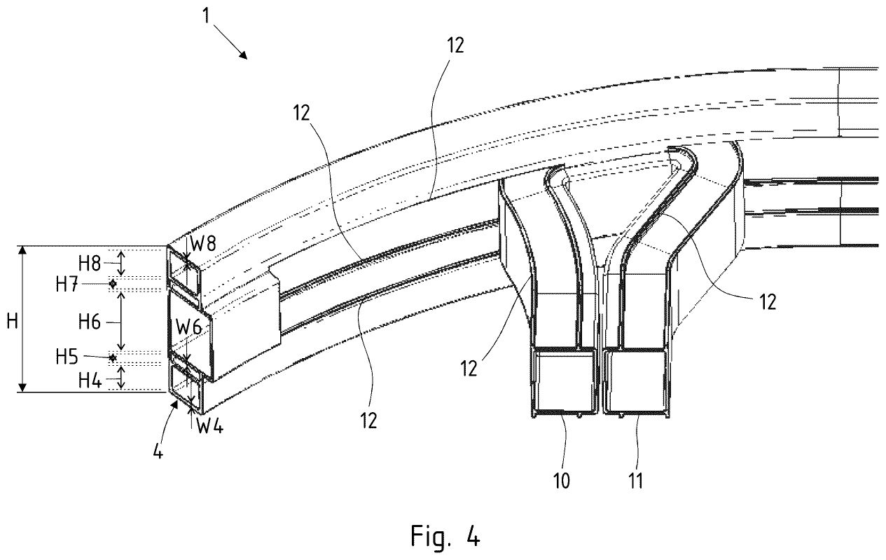

As can be seen in FIG. 4, which shows a detailed view of the first embodiment of the crash management system 1, both profile segments 10 and 11 as well as the profile chambers 4 and 8 of the cross member 2 include remnants 12 of the profile chambers 5 and 7 through which has been cut.

FIG. 2 shows a front view of the first embodiment of the crash management system 1. The front view refers to the orientation of the crash management system 1 when mounted in a vehicle. The cut is able to be made for bending the respective outer profile segments 10 backwards, and does not extend to the end of the free end sections 13 of the cross member 2. Therefore, a section of the inner profile chamber 6, from which the crash absorbing components 3 are formed, remains at the free end section 13 and connects the outer profile chambers 4 and 8, which form the cross member 2. This gives the cross member 2 more stiffness and insures an even distribution of the impact energy.

FIG. 4 shows, that the height H5, H7 of the profile chambers 5, 7 that are arranged between the outer profile chambers 8, 4 of the cross member 2 and the inner profile chamber 6 from which the crash absorbing components 3 are formed, is smaller compared to the height H4, H6, H8 of the other profile chambers 4, 6, 8. The height H5, H7 of the connecting profile chambers 5, 7 ranges from 5 mm to 15 mm. This has the advantage, that the height H5, H7 of the connecting profile chambers 5, 7 is large enough to ensure that the cut necessary for bending the profile segments 10, 11 backwards extends through the connecting profile chambers 5, 7, while not being too large so that they compromise the stability of the crash management system 1.

The overall height H of the crash management systems 1 ranges from 100 mm to 250 mm, 150 to 220 mm. The height H6 of the profile chamber (6), which form the crash absorbing components, accounts for 40 to 60% of the overall height H.

The wall thickness W4, W8 of the outer profile chambers 4, 8 of the cross member 2 is higher compare to the wall thickness W6 of the inner profile chamber 6 from which the crash absorbing components 3 are formed. This has the added benefit, that the cross member 2 is more rigid than the crash absorbing components 3, which is beneficial for the distribution of the impact energy.

The wall thickness W4, W6, W8 of the profile chambers 4, 6, 8 ranges from 1 mm to 15 mm.

The crash management system 1 is made out of a 6000 or 7000 series aluminum alloy with a tensile strength ranging from 200 MPa to 400 MPa.

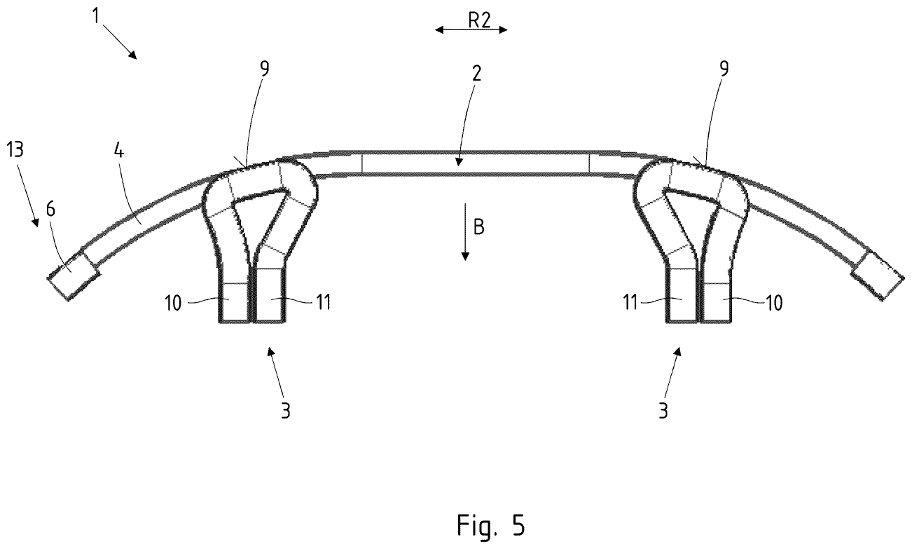

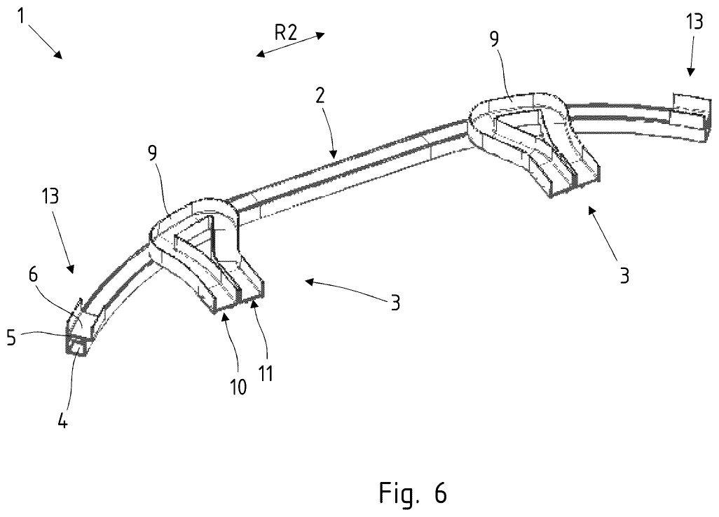

FIG. 5 and FIG. 6 show the first embodiment of the crash management system 1. FIG. 5 shows the crash management system 1 from a top view on horizontal cut at 50% height, wherein top view refers to the top view of the crash management system 1 in its mounted state in a vehicle. FIG. 6 shows a prospective view of the crash management system 1. The crash management system 1 of the first embodiment is made from a single extruded profile including three profile chambers 4, 5, 6, which extend in longitudinal direction R1 of the single extruded profile 21. In order to bend the profile chamber 6 in a backward direction B to form the crash absorbing components 3, the inner profile chamber 5 connecting the outer profile chambers 4, 6 is cut in a longitudinal direction of the single extruded profile 21 on both sides of the base area 9 of the crash management system 1, creating the pre-cut profile segments 10, 11. The cross member 2 is formed by the remaining outer profile chamber 4.

The cross member 2 also includes a section of the outer profile 6 from which the crash absorbing components 3 are formed, at its free end sections 13.

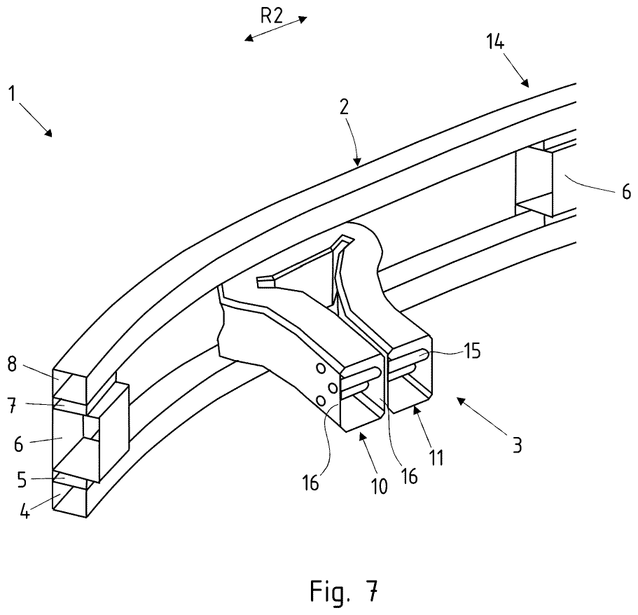

FIG. 7 shows a detailed view of a second embodiment of the crash management system 1. The general structure of the crash management system 1 is in accordance with the structure of the first embodiment. However, a middle section 14 of the cross member 2 includes a section of the inner profile 6 from which the crash absorbing components 3 are formed. This increases the stability of the crash management system 1. Each of the pre-cut profile segments 10, 11 of the crash absorbing components 3 includes three reinforcement elements 15 for connection to the car body, which connect the two vertical walls 16 of the pre-cut profile segments 10, 11. The reinforcement elements 15 improve the impact energy absorption of the crash management system 1.

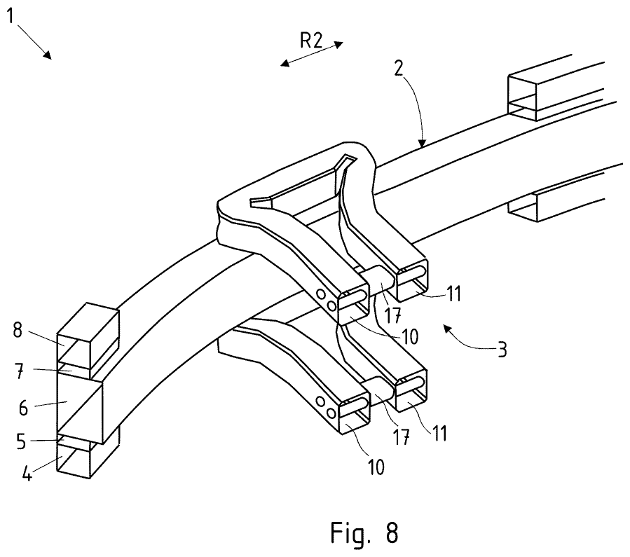

FIG. 8 shows a third embodiment of the crash management system 1, where the single extruded profile 21 from which the cross member 2 and the crash absorbing components 3 are made includes five profile chambers 4, 5, 6, 7, 8. Here, the crash absorbing components 3 are formed by bending the pre-cut elements 10, 11 originating from both outer profile chambers 4 and 8 backwards. The cross member 2 is formed from the middle profile chamber 6. The crash absorbing components 3 thus include upper and lower profile segments 10, 11, which are able to be beneficial for impact energy absorption depending on the designated use case.

Both the upper and lower profile segments 10, 11 are connected with one another by a second reinforcement element 17, which extends from the pre-cut profile segment 10 to the other pre-cut profile segment 11 in longitudinal direction R2 of the cross member 2.

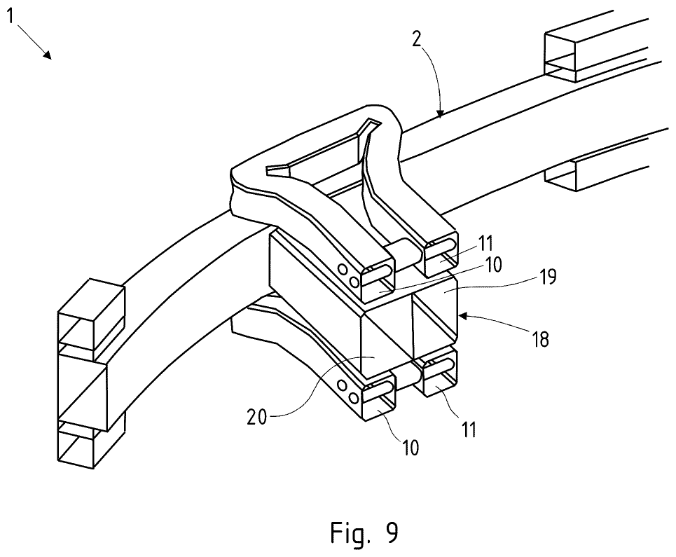

FIG. 9 shows a fourth embodiment of the crash management system 1. In contrast to the third embodiment shown in FIG. 8, an additional crash profile 18 is fixed to the cross member 2 and positioned between the upper profile segments 10, 11 and lower profile segments 10, 11. The crash profile 18 includes two profile chambers 19, 20. This configuration allows additional freedom of the design of the crash absorbing components 3, which are able to be tailored to the respective use case.

In order to produce the crash management system 1, a single extruded profile 21, which includes five profile chambers 4, 5, 6, 7, 8 in longitudinal direction R1 of the single extruded profile 21 is provided.

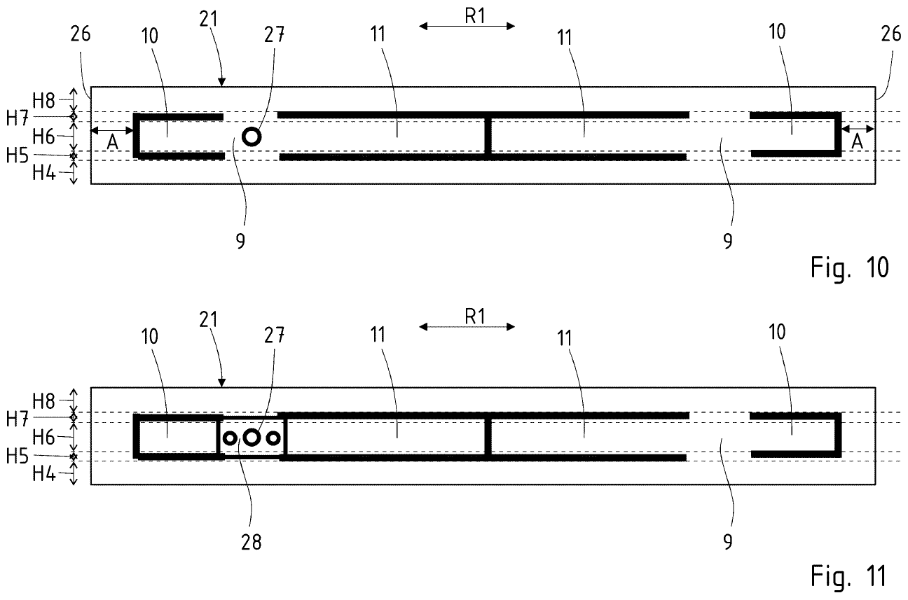

FIG. 10 shows the next step of the production procedure. Here, the single extruded profile 21 is precut into four pre-cut profile segments, two outer pre-cut profile segments 10 and two inner pre-cut profile segments 11. Each of the pre-cut profile segments 10, 11 is formed by two cuts in longitudinal direction R1 of the single extruded profile 21, which are parallel to one another. The respective longitudinal cuts extend through the profile chambers 5 and 7, which connect the outer profile chambers 4, 8 with the inner profile chamber 6. The heights H5 and H7 of the connecting profile chambers 5, 7 are lower compared to the heights H4, H6 and H8 of the outer profile chambers 4, 8 and inner profile chamber 6. The main purpose of the connecting profile chambers 5, 7 is to provide space for the cut required to produce the pre-cut profile segments 10, 11.

The pre-cut profile segments 10, 11 include sections of the inner profile chamber 6 as well as the remnants of the connecting profile chambers 5, 7 which are still attached to the inner profile chamber 6. The outer pre-cut profile segments 10 also include a cut which is perpendicular to the longitudinal direction R1 of the single extruded profile 21. These cuts connect the two parallel cuts in longitudinal direction R1 of the single extruded profile 21 and have a distance A of 10-200 mm from the outer edges 26 of the single extruded profile 21.

The inner pre-cut profile segments 11 are separated from one another by a further cut, which is also perpendicular to the longitudinal direction R1 of the single extruded profile 21 and connects the two parallel cuts in longitudinal direction R1.

The respective inner and outer pre-cut profile segments 10, 11 remain attached to a base area 9 of the single extruded profile 21 with respective ends opposite to the cuts perpendicular to the longitudinal direction R1 of the single extruded profile 21. These base areas 9 are thus positioned between the outer precut profile segments 10 and the respective inner precut profile segments 11. The precut profile segments 10, 11 extend in longitudinal direction R1 of the single extruded profile 21 starting on opposite sides of the respective base area 9.

During the pre-cutting stage, a hole 27 is cut in one of the base areas 9. The hole 27 can be used for mounting a towing sleeve, once the produced crash management system 1 is attached to a vehicle.

FIG. 11 shows the next step of the production procedure. Here, a towing block 28 is inserted into the inner profile chamber 6 and pushed to the base area 9 in which the hole 27 for mounting the towing sleeve has been cut. The towing block 28 includes a thread for screwing in the towing sleeve and is fixed to the single extruded profile 21 with bolts.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-15. (canceled)

16. A crash management system for a vehicle, the crash management system comprising:
a cross member; and
two crash absorbing components,
wherein the cross member and at least one crash absorbing component of the two crash absorbing components constitute a single extruded profile, the single extruded profile comprising at least two profile chambers which extend in a longitudinal direction of the single extruded profile,
wherein the cross member comprises at least one first profile chamber of the at least two profile chambers of the single extruded profile,
wherein the at least one crash absorbing component is configured from the single extruded profile in one piece and of the same material and comprises at least two profile segments which are pre-cut and bent from the single extruded profile, each of the at least two profile segments comprising a section of at least one second profile chamber of the at least two profile chambers bent in a backward direction,
wherein the at least two profile segments remain connected with opposite sides of a base area, and
wherein the base area is a section of the at least one second profile chamber that comprises a part of the at least one crash absorbing component that is connected to the at least one first profile chamber of the cross member, so that the at least one crash absorbing component comprises the at least two profile segments which are at least two neighboring profile segments arranged next to each other in a longitudinal direction of the cross member and extending transverse to the longitudinal direction of the cross member.

17. The crash management system according to claim 16, wherein both of the two crash absorbing components constitute the single extruded profile.

18. The crash management system according to claim 16, wherein the cross member and the two crash absorbing components constitute the single extruded profile having at least three profile chambers in the longitudinal direction of the single extruded profile.

19. The crash management system according to claim 16, wherein at least one free end section of the cross member comprises a section of the at least one second profile chamber from which the at least one crash absorbing component is formed.

20. The crash management system according to claim 16, wherein a third profile chamber of the at least two profile chambers is arranged between
the at least one first profile chamber from which the cross member is formed, and
the at least one second profile chamber from which the at least one crash absorbing component is formed.

21. The crash management system according to claim 20, wherein
a height of the third profile chamber is smaller than a height of the at least one first profile chamber of the cross member and a height of the at least one second profile chamber of the at least one crash absorbing component, and ranges from 5 mm to 15 mm.

22. The crash management system according to claim 16, wherein an overall height of the crash management system ranges from 100 mm to 250 mm, and the at least one second profile chamber, which forms the at least one crash absorbing component, accounts for 40% to 60% of the overall height of the crash management system.

23. The crash management system according to claim 16, wherein the at least one crash absorbing component comprises additional profile elements, which are positioned between the at least two neighboring profile segments.

24. The crash management system according to claim 16, wherein
the at least one second profile chamber forming the at least one crash absorbing component comprises an inner profile chamber among the at least two profile chambers of the single extruded profile, and
the at least one first profile chamber forming the cross member comprises outer profile chambers among the at least two profile chambers of the single extruded profile.

25. The crash management system according to claim 16, wherein
the at least one second profile chamber forming the at least one crash absorbing component comprises outer profile chambers among the at least two profile chambers of the single extruded profile, and
the at least one first profile chamber forming the cross member comprises an inner profile chamber among the at least two profile chambers of the single extruded profile.

26. The crash management system according to claim 16, further comprising a towing block inserted into an inner profile chamber among the at least two profile chambers of the single extruded profile.

27. A method of producing a crash management system for a vehicle comprising a cross member and two crash absorbing components, the method comprising:
pre-cutting a single extruded profile, which comprises at least two profile chambers in a longitudinal direction of the single extruded profile, to form pre-cut profile segments, wherein the pre-cut profile segments comprise at least one profile chamber of the at least two profile chambers and remain attached to a portion of the single extruded profile which comprises a base area of a respective crash absorbing component to be formed, wherein the pre-cut profile segments extend in the longitudinal direction of the single extruded profile starting on opposite sides of the base area;
forming the cross member by curving free end sections of the single extruded profile; and
forming at least one crash absorbing component of the two crash absorbing components by bending the pre-cut profile segments away from the cross member in a backward direction and subsequently pressing the pre-cut profile segments together in a longitudinal direction of the cross member, so that the pre-cut profile segments are arranged next to each other in the longitudinal direction of the cross member and extend transverse to the longitudinal direction of the cross member.

28. The method according to claim 27, further comprising:
cutting one or more holes for mounting a towing sleeve into the base area of the single extruded profile during the pre-cutting.

29. The method according to claim 28, further comprising:
after the pre-cutting, positioning a receiving block for receiving the towing sleeve underneath a hole of the one or more holes inside the at least one profile chamber from which the at least one crash absorbing component is formed.

30. The method according to claim 27, further comprising:
connecting coupling elements for connecting the crash management system with the vehicle with free ends of the two crash absorbing components.

31. The crash management system according to claim 16, wherein the cross member and the two crash absorbing components constitute the single extruded profile having at least five profile chambers in the longitudinal direction of the single extruded profile.

32. The crash management system according to claim 16, wherein a middle section of the cross member comprises a section of the at least one second profile chamber from which the at least one crash absorbing component is formed.

33. The crash management system according to claim 16, wherein an overall height of the crash management system ranges from 150 mm to 220 mm, and the at least one second profile chamber, which forms the at least one crash absorbing component, accounts for 40% to 60% of the overall height of the crash management system.

34. The method according to claim 27, further comprising:
connecting backplates for connecting the crash management system with the vehicle with free ends of the two crash absorbing components.
